(19) United States
(12) Patent Application Publication
(10) Pub. No.: US 2025/0308535 A1
(43) Pub. Date: Oct. 2, 2025

(54) APPARATUS AND METHOD FOR OWN VOICE DETECTION

(71) Applicant: Realtek Semiconductor Corporation, Hsinchu (TW)

(72) Inventors: Chun-Ming YANG, Hsinchu (TW); Shih-Chieh HUANG, Hsinchu (TW)

(21) Appl. No.: 18/955,888

(22) Filed: Nov. 21, 2024

(30) Foreign Application Priority Data
Mar. 29, 2024 (TW) 113112228

(51) Int. Cl. G10L 17/06

(52) U.S. Cl. CPC G10L 17/06

(57) ABSTRACT

An own voice detection method includes a training phase and a detection phase. The training phase includes: receiving a first audio signal and a second audio signal from a first sound receiver and a second sound receiver; performing a voice activity detection to determine whether a voice activity is present; and training a filter based on the first and second audio signals when the voice activity is present, thereby finding optimal filter coefficients. The detection phase includes: receiving the first audio signal and the second audio signal from the first and second sound receivers; inputting the first audio signal to the filter with the optimal filter coefficients to obtain a third audio signal; and comparing to obtain a similarity index between the third and second audio signals, and determining that own voice is present when the similarity index is greater than a threshold.

### CROSS-REFERENCE TO RELATED APPLICATION

This application claims priority to Taiwan Application Serial Number 113112228, filed Mar. 29, 2024, which is herein incorporated by reference in its entirety.

### BACKGROUND

### Technical Field

The present disclosure relates to an own voice detection apparatus and an own voice detection method. More particularly, the present disclosure relates to an apparatus and a method for own voice detection by comparing a similarity index between two audio signals.

### Description of Related Art

Own voice detection (OVD) is a necessary function of hearing aid(s) (or a personal sound amplifier product), and the OVD performance directly determines the market acceptance of the hearing aid. Generally, if there is no special treatment for own voice, the hearing aid will amplify all recorded sounds. When the wearer speaks, his or her own voice will be transmitted through the skull to the ear canal, causing an aural fullness feeling, and/or his or her own voice will be transmitted to the hearing aid through the air, and the wearer may feel uncomfortable because the amplified own voice is too loud. The aural fullness feeling may be solved by releasing the sound pressure, but the amplified uncomfortable own voice often forces the wearer to lower the volume of the hearing aid, resulting in limited actual hearing aid effect.

If the hearing aid is equipped with the own voice detection function, the own voice may be suppressed when it is well detected. In this case, the hearing aid may accordingly increase the overall volume, thereby achieving better hearing aid effect.

The known own voice detection technologies have some disadvantages, such as a requirement of additional configuration of bone conduction sensors, or a requirement of additional configuration of in-ear microphones, or a requirement of using high-computation blind source separation (BSS) algorithm, or a requirement of using artificial intelligence voiceprint recognition technology with high computational load and high storage demand, or a requirement of a large amount of data exchange that needs to be exchanged between the two hearing aids, or problems that the convergence speed and the response time of algorithm are not fast enough, a requirement of using more than two sets of adaptive filters, or a combination of at least two of the aforementioned issues. These disadvantages may cause shortcomings such as increased cost, high computational load, high storage demand, large amount of data exchange, and the algorithm may be difficult to converge, and/or the algorithm may not respond swiftly.

Therefore, it is necessary to develop a new own voice detection algorithm that performs signal analysis by only using out-of-ear sound receivers (or out-of-ear microphones) necessary for general hearing aids or wireless earbuds. At the same time, the new own voice detection algorithm must be simple, occupy low computational load and low storage demand, and can operate independently on a single hearing aid, and can be widely used in most hearing aids or wireless earbuds on the market.

### SUMMARY

The disclosure provides an own voice detection apparatus including a first sound receiver, a second sound receiver, and a signal processor communicatively connected to the first sound receiver and the second sound receiver. The signal processor performs an own voice detection method including a training phase and a detection phase. During the training phase, the signal processor is used to: receive a first audio signal from the first sound receiver and receive a second audio signal from the second sound receiver; perform a voice activity detection based on the first audio signal or the second audio signal, thereby determining whether a voice is present; and train a filter based on the first audio signal and the second audio signal when the voice is present, thereby finding optimal filter coefficients for optimizing the filter. The optimal filter coefficients reflect a frequency response difference between two acoustic paths from a wearer's mouth to the first and second sound receivers respectively. During the detection phase, the signal processor is used to: receive the first audio signal from the first sound receiver and receive the second audio signal from the second sound receiver; filter the first audio signal by the filter with the optimal filter coefficients to obtain a third audio signal; compare the third audio signal and the second audio signal to obtain a similarity index between the third audio signal and the second audio signal; and determine that the first audio signal and the second audio signal contain own voice when the similarity index is greater than a threshold.

The disclosure further provides an own voice detection method including a training phase and a detection phase. The training phase includes steps of: receiving a first audio signal from a first sound receiver and receiving a second audio signal from a second sound receiver; performing a voice activity detection based on the first audio signal or the second audio signal, thereby determining whether a voice activity is present; and training a filter based on the first audio signal and the second audio signal when the voice activity is present, thereby finding optimal filter coefficients for optimizing the filter. The optimal filter coefficients reflect a frequency response difference between two acoustic paths from a wearer's mouth to the first and second sound receivers respectively. The detection phase includes steps of: receiving the first audio signal from the first sound receiver and receiving the second audio signal from the second sound receiver; filtering the first audio signal by the filter with the optimal filter coefficients to obtain a third audio signal; comparing the third audio signal and the second audio signal to obtain a similarity index between the third audio signal and the second audio signal; and determining that the first audio signal and the second audio signal contain own voice when the similarity index is greater than a threshold.

In order to let the present disclosure and other objects, features, advantages, and embodiments of the present disclosure mentioned above to be more easily understood, the descriptions of the accompanying drawings are as follows.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a diagram of an own voice detection apparatus according to one embodiment of the present disclosure.

FIG. 2 is a flowchart of a training phase of an own voice detection method according to one embodiment of the present disclosure.

FIG. 3 is a flowchart of a detection phase of an own voice detection method according to one embodiment of the present disclosure.

### DETAILED DESCRIPTION

Specific embodiments of the present disclosure are further described in detail below with reference to the accompanying drawings, however, the embodiments described are not intended to limit the present disclosure and it is not intended for the description of operation to limit the order of implementation.

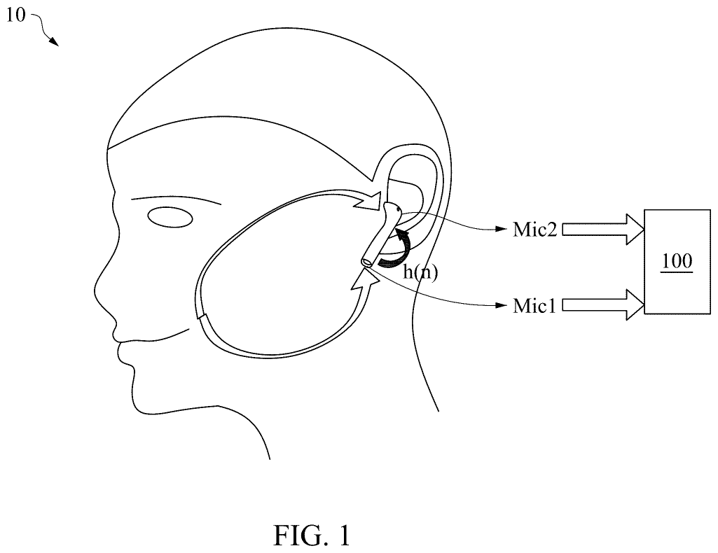

FIG. 1 is a diagram of an own voice detection apparatus 10 according to one embodiment of the present disclosure. The own voice detection apparatus 10 includes a first sound receiver Mic1, a second sound receiver Mic2, and a signal processor 100. In the embodiment of the present disclosure, the signal processor 100 is an electronic component with computing capabilities such as a central processing unit (CPU), a microprocessor, a microcontroller, a digital signal processor (DSP), and an application specific integrated circuit (ASIC). In the embodiment of the present disclosure, the signal processor 100 may be communicatively connected to the first sound receiver Mic1 and the second sound receiver Mic2 via wired or wireless communication. In the embodiment of the present disclosure, the first sound receiver Mic1 and the second sound receiver Mic2 are out-of-ear sound receivers (or out-of-ear microphones).

In the embodiment of the present disclosure, during a training phase, the signal processor 100 trains a filter based on the sample audio signals received from the first sound receiver Mic1 and the second sound receiver Mic2. In the embodiment of the present disclosure, during a detection phase after the training phase, the signal processor 100 filters an audio signal received by the first sound receiver Mic1 by utilizing the trained filter, and then the signal processor 100 compares the signal output by the filter with another audio signal received by the second sound receiver Mic2 to determine whether the audio signals contain own voice.

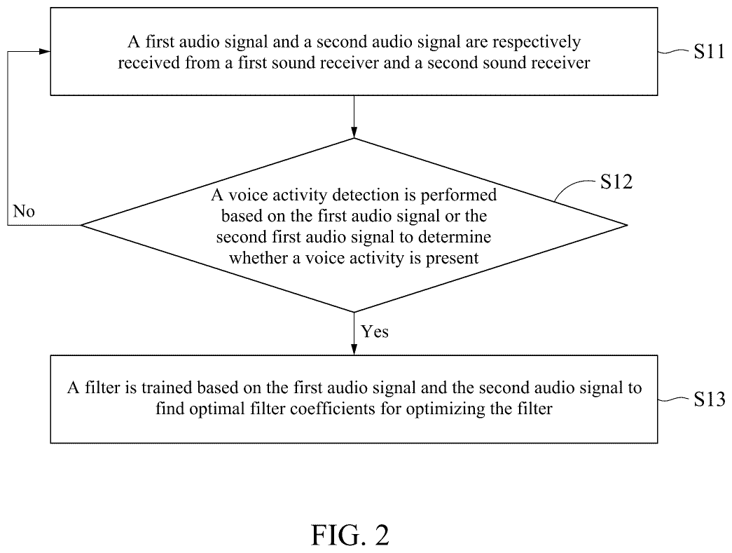

Regarding the aforementioned training phase, please refer to FIG. 1 and FIG. 2. FIG. 2 is a flowchart of a training phase of an own voice detection method according to one embodiment of the present disclosure. At step S11, the signal processor 100 receives a first audio signal (or a first sample audio signal) from the first sound receiver Mic1 and receives a second audio signal (or a second sample audio signal) from the second sound receiver Mic2. At step S12, the signal processor 100 performs a voice activity detection (VAD) based on the first audio signal or the second audio signal, thereby determining whether a voice activity is present at this time. Step S13 is performed only when it is determined that the voice activity is present at this time. In addition, if it is determined that the voice activity is not present at this time at step S12, the said method returns to step S11. At step S13, the signal processor 100 trains a filter based on the first audio signal and the second audio signal, thereby finding optimal filter coefficients for optimizing the filter. The optimal filter coefficients reflect a frequency response difference (e.g., a function h(n) as shown in FIG. 1) between two acoustic paths from a wearer's mouth to the first sound receiver and the second sound receiver respectively.

It should be noted that the training phase is performed in a silent environment (in the present disclosure, the silent environment is defined as that in which a sound pressure level does not exceed 50 decibels) to ensure that the first audio signal and the second audio signal received at step S11 are originated from the wearer's mouth. In the embodiment of the present disclosure, during the training phase, the wearer of the own voice detection apparatus 10 utters several own voice sentences through the wearer's mouth, so that there will be several first sample audio signals and several second sample audio signals during the training phase. The own voice detection apparatus 10 will utilize these sample audio signals to find the optimal filter coefficients. It is worth mentioning that the training phase usually only needs to be performed once and can be completed within a few seconds (e.g., within ten seconds).

The VAD at step S12 can ensure that the training of the filter at step S13 is performed only when the VAD determines that the voice activity is present, so as to achieve more accurate convergence results. Specifically, the VAD at step S12 is to perform VADs on the first audio signal and the second audio signal, respectively, and the determination result in step S12 is “YES” only when a VAD result of the first audio signal and a VAD result of the second audio signal both show that the voice activity is present.

In the embodiment of the present disclosure, the filter of step S13 is configured to model the relative transfer function (e.g., the function h(n) shown in FIG. 1) between the first audio signal received from the first sound receiver Mic1 and the second audio signal received from the second sound receiver Mic2.

In the embodiment of the present disclosure, at step S13, the signal processor 100 optimizes the filter according to an objective function shown in the following equation (1):

$${min}_{h} E [ {Mic}_{2} - h * {Mic}_{1} ] , \qquad ( 1 )$$

where h is a vector of filter coefficients (e.g., the function h(n) shown in FIG. 1), Mic₁ is the first audio signal, Mic₂ is the second audio signal, and E is a mathematical expectation (also called an expected value in mathematics). The optimal filter coefficients are the filter coefficients that make the objective function attains a minimum value. In other words, the optimal filter coefficients are found by optimizing the filter based on the objective function shown in the aforementioned equation (1). In the embodiment of the present disclosure, the signal processor 100 may find the optimal filter coefficients by utilizing any searching method, such as a least mean square error (LMSE) algorithm, a normalized least mean square error algorithm, or an adaptive least mean square error algorithm. The present disclosure does not restrict the searching method for finding the optimal filter coefficients. Those skilled in the art should appreciate how to use the aforementioned example searching method to solve the optimized problem under the given objective function, and the process of finding the optimal filter coefficients will not be described in detail herein. If the embodiment described here is implemented in the time domain, then the symbol “*” in the aforementioned equation (1) is convolution; and if the embodiment described here is implemented in the frequency domain, then the symbol “*” in the aforementioned equation (1) is multiplication.

In another embodiment of the present disclosure, in step S13, the signal processor 100 may perform a mathematical operation on the first audio signal to obtain a third audio signal. Then, the signal processor 100 calculates the optimal filter coefficients by performing an optimization process with a goal to maximize the similarity index between the third audio signal and the second audio signal. If the embodiment described here is implemented in the time domain, the above mathematical operation is convolution. If the embodiment described here is implemented in the frequency domain, the above mathematical operation is multiplication. The aforementioned similarity index can be defined by a cosine similarity between the third audio signal and the second audio signal, or the aforementioned similarity index can be defined by a correlation coefficient between the third audio signal and the second audio signal.

Regarding the manner for calculating the optimal filter coefficients, the adaptive least mean square error algorithm is taken as an example here. When the n-th sample audio signal is read in, the error err is calculated according to the following equation (2):

$$err = ( {Mic}_{2} - h * {Mic}_{1} ) ( n ) . \qquad ( 2 )$$

Then, the vector of filter coefficients h is updated according to the error err, and the updated manner is shown in the following equation (3):

$${h}^{′} = h + {μ}_{0} \cdot VAD\_flag \cdot err \cdot {Mic}_{1} , \qquad ( 3 )$$

where h′ is the updated vector of filter coefficients. h and Mic₁ in the equation (3) are N-dimensional row vectors. That is, h=(h₀, h₁, . . . , h_{N-1})^{T}, and Mic₁=(Mic₁[n], Mic₁[n−1], . . . , Mic₁[n−N+1])^{T}. The convergence step factor μ₀ is a given positive number. When the result of the VAD at step S12 is “YES”, VAD_flag=1, and h′ is updated according to the equation (3). On the contrary, when the result of the VAD at step S12 is “NO”, VAD_flag=0, and h′ is not updated. The above case is an example for solving the optimal filter coefficients in the time domain.

Similarly, the vector of filter coefficients H can also be solved in the frequency domain. First, the discrete Fourier transform pairs are defined according to the following equations (4), (5) and (6):

$$h [ n ] ↔ H [ k ] , \qquad ( 4 )$$

$${Mic}_{1} [ n ] ↔ {MIC}_{1} [ k ] , and \qquad ( 5 )$$

$${Mic}_{2} [ n ] ↔ {MIC}_{2} [ k ] . \qquad ( 6 )$$

Then, the error ERR[k] is calculated in each frame according to the following equation (7):

$$ERR [ k ] = ( {MIC}_{2} [ k ] - H [ k ] \cdot {MIC}_{1} [ k ] ) ( n ) . \qquad ( 7 )$$

Then, the vector of filter coefficients H[k] is updated according to the error ERR [k], and the updated manner is shown in the following equation (8):

$${H}^{′} [ k ] = H [ k ] + {μ}_{0} \cdot VAD\_flag \cdot \vert ERR [ k ] \vert \cdot {MIC}_{1} [ k ] . \qquad ( 8 )$$

The above case is an example for solving the optimal filter coefficients in the frequency domain.

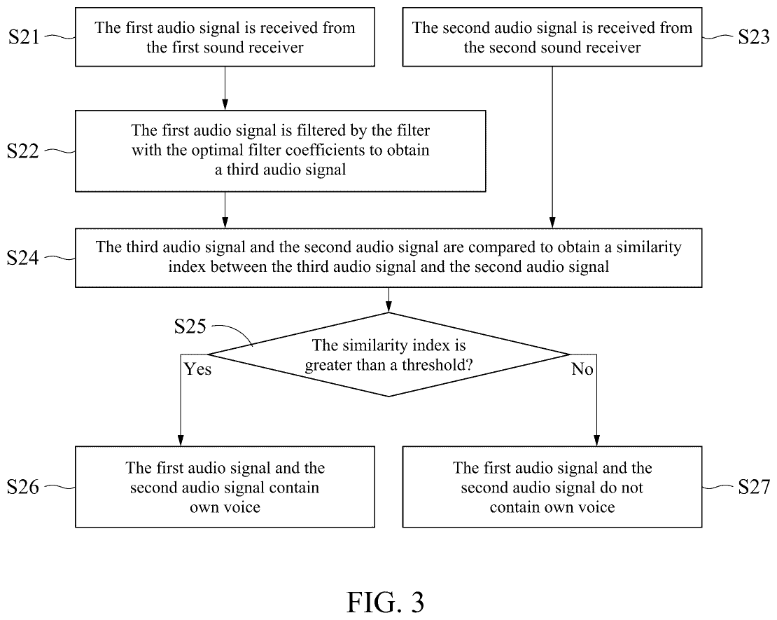

Regarding the aforementioned detection phase, please refer to FIG. 1 and FIG. 3. FIG. 3 is a flowchart of a detection phase of an own voice detection method according to one embodiment of the present disclosure. At step S21, the signal processor 100 receives a first audio signal from the first sound receiver Mic1. At step S22, the signal processor 100 filters the first audio signal received from the first sound receiver Mic1 by utilizing the filter with the optimal filter coefficients so as to obtain a third audio signal. At step S23, the signal processor 100 receives a second audio signal from the second sound receiver Mic2. At step S24, the signal processor 100 compares the third audio signal and the second audio signal to obtain a similarity index between the third audio signal and the second audio signal. The aforementioned similarity index can be defined by a cosine similarity or a correlation coefficient between the third audio signal and the second audio signal. At step S25, the signal processor 100 determines whether the similarity index obtained at step S24 is greater than a given threshold. If the similarity index is greater than the threshold, the signal processor 100 determines that the first audio signal and the second audio signal contain own voice at step S26. If the similarity index is not greater than the threshold, the signal processor 100 determines that the first audio signal and the second audio signal do not contain own voice at step S27.

In other words, the filter at step S22 utilizes the optimal filter coefficients to filter the first audio signal, thereby generating the third audio signal.

It is worth mentioning that the optimal filter coefficients have been applied to the filter at step S22. In other words, the filter at step S22 fixedly utilizes the optimal filter coefficients, and thus the filter at step S22 is not an adaptive filter that needs to continuously update the filter coefficients. Accordingly, the own voice detection of the embodiment of the present disclosure has a fast response time in the detection phase and does not have the risk that the algorithm may not converge.

In addition, the threshold at step S25 can be a value set by the designer based on actual needs, such as 0.9995 or 0.999. The present disclosure does not restrict the value of the threshold.

In the embodiment of the present disclosure, the similarity index comparison method is based on the consistency of phase and amplitude, and therefore the similarity index comparison method is more reliable than the power comparison method that only relies on amplitude. The similarity index comparison method can be implemented in many ways, as shown below with an example.

First, the first audio signal is filtered by the filter with the optimal filter coefficients so as to obtain the third audio signal, and the third audio signal is expressed as sig1=h*Mic₁, and the second audio signal is expressed as sig2=Mic₂. From the aspect of phase, the cosine similarity between sig1 and sig2 satisfies the following equation (9):

$$\frac{sig 1 \cdot sig 2}{{‖ sig 1 ‖}_{2} {‖ sig 2 ‖}_{2}} > threshold . \qquad ( 9 )$$

The threshold can be set as 0.9995. The subscript 2 represents L2-norm of the vector. sig1 sig2 is a short time inner product, as shown in equation (10):

$$sig 1 \cdot sig 2 = {\sum }_{i = 0}^{M - 1} sig 1 [ n - i ] \cdot sig 2 [ n - i ] , \qquad ( 10 )$$

where M is a positive integer. On the other hand, from the aspect of amplitude, the amplitude of sig1 should be comparable with the amplitude of sig2. For example, the amplitude of sig1 and the amplitude of sig2 satisfy the following equation (11):

$$sig 1 \cdot sig 2 > γ sig 1 \cdot sig 2 , \qquad ( 11 )$$

where γ is the threshold, which may be set as 0.999.

Specifically, the purpose of own voice detection is to detect whether the wearer is uttering his or her own voice and to adjust the volume of the hearing aid accordingly, thereby providing a better wearer experience. Therefore, when own voice is determined to be present at step S26, the first audio signal and the second audio signal may be correspondingly subjected to subsequent corresponding processing, such as suppressing the first audio signal and the second audio signal. The present disclosure does not restrict the processing method used when own voice is determined to be present.

Specifically, some of the known own voice detection methods usually directly perform signal analysis on the audio signals received by the sound receiver to determine whether own voice is present. In contrast, the own voice detection method of the present disclosure includes a training phase and a detection phase. The optimal filter coefficients are found in the training stage, and then the optimal filter coefficients are applied to the filter in the detection stage to determine whether own voice is present. Therefore, the present disclosure can better improve the accuracy of own voice detection, reduce the computational load, and shorten the response time.

In the embodiment of the present disclosure, when the own voice detection apparatus 10 is worn on a head of a wearer, the first sound receiver Mic1 and the second sound receiver Mic2 are both located at the same ear of the wearer (for example, the left ear of the wearer shown in FIG. 1). In the embodiment of the present disclosure, it should be noted that, as shown in FIG. 1, when the own voice detection apparatus 10 is worn on the head of the wearer, the first sound receiver Mic1 is closer to the wearer's mouth than the second sound receiver Mic2. This is because compared to the second sound receiver Mic2, the first audio signal received by the first audio receiver Mic1 needs to be input into the filter, and then the related signal process is performed on the filtered first audio signal and the second audio signal received by the second sound receiver Mic2. Therefore, the first sound receiver Mic1 is closer to the wearer's mouth than the second microphone Mic2, thereby better compensating the time delay introduced by the filter.

In the embodiment of the present disclosure, as mentioned above, the first sound receiver Mic1 and the second sound receiver Mic2 are both located at the same ear of the wearer. Therefore, the own voice detection apparatus 10 proposed by the present disclosure can operate independently for one ear. On the other hand, in another embodiment of the present disclosure, the function of exchanging data between two sound receivers may be added, that is, another set of own voice detection apparatus is configured in the other ear of the wearer. These two sets of the own voice detection apparatus may work together, and only when both the two sets of the own voice detection apparatus determine that own voice is present, own voice is determined to be present. This will improve the accuracy of own voice detection by binaural hearing aids.

To sum up, the own voice detection apparatus and the own voice detection method proposed by the present disclosure only use out-of-ear sound receivers necessary for general hearing aids or wireless earbuds to perform signal analysis. The own voice detection apparatus and own voice detection method proposed by the present disclosure have advantages of high accuracy, low computational load, short response time. The own voice detection apparatus and own voice detection method proposed by the present disclosure can operate independently on a single hearing aid. The own voice detection apparatus and own voice detection method proposed by the present disclosure can be widely used in most hearing aids or wireless earbuds on the market.

Although the present disclosure has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. An own voice detection apparatus, comprising:
a first sound receiver;
a second sound receiver; and
a signal processor communicatively connected to the first sound receiver and the second sound receiver,
wherein the signal processor is configured to perform an own voice detection method including a training phase and a detection phase,
wherein during the training phase, the signal processor is configured to:
receive a first audio signal from the first sound receiver and receive a second audio signal from the second sound receiver;
perform a voice activity detection based on the first audio signal or the second audio signal, thereby determining whether a voice activity is present; and
train a filter based on the first audio signal and the second audio signal when the voice activity is present, thereby finding optimal filter coefficients for optimizing the filter, wherein the optimal filter coefficients reflect a frequency response difference between two acoustic paths from a wearer's mouth to the first and second sound receivers respectively;
wherein during the detection phase, the signal processor is configured to:
receive the first audio signal from the first sound receiver and receive the second audio signal from the second sound receiver;
filter the first audio signal by the filter with the optimal filter coefficients to obtain a third audio signal;
compare the third audio signal and the second audio signal to obtain a similarity index between the third audio signal and the second audio signal; and
determine that the first audio signal and the second audio signal contain own voice when the similarity index is greater than a threshold.

2. The own voice detection apparatus of claim 1, wherein when the own voice detection apparatus is worn on a head of a wearer, the first sound receiver and the second sound receiver are located at the same ear of the wearer.

3. The own voice detection apparatus of claim 2, wherein when the own voice detection apparatus is worn on the head of the wearer, the first sound receiver is closer to the wearer's mouth than the second sound receiver.

4. The own voice detection apparatus of claim 1, wherein the training phase is performed in a silent environment, and a sound pressure level of the silent environment does not exceed 50 decibels.

5. The own voice detection apparatus of claim 1, wherein the similarity index is a cosine similarity between the third audio signal and the second audio signal.

6. The own voice detection apparatus of claim 1, wherein the similarity index is a correlation coefficient between the third audio signal and the second audio signal.

7. The own voice detection apparatus of claim 1, wherein the signal processor optimizes the filter according to an objective function:
$${min}_{h} E [ {Mic}_{2} - h * {Mic}_{1} ] ,$$
wherein h is a vector of filter coefficients, Mic₁ is the first audio signal, Mic₂ is the second audio signal, and E is a mathematical expectation, and wherein the optimal filter coefficients are the filter coefficients that makes the objective function attains a minimum value.

8. The own voice detection apparatus of claim 1, wherein the signal processor finds the optimal filter coefficients by utilizing a least mean square error algorithm, a normalized least mean square error algorithm, or an adaptive least mean square error algorithm.

9. The own voice detection apparatus of claim 1, wherein the signal processor performs a mathematical operation on the first audio signal to obtain the third audio signal, and then the optimal filter coefficients are calculated by performing an optimization process with a goal to maximize the similarity index between the third audio signal and the second audio signal.

10. The own voice detection apparatus of claim 9, wherein when the filter is optimized in time domain, the mathematical operation is convolution.

11. The own voice detection apparatus of claim 9, wherein when the filter is optimized in frequency domain, the mathematical operation is multiplication.

12. An own voice detection method, comprising:
performing a training phase, and the training phase comprises steps of:
receiving a first audio signal from a first sound receiver and receiving a second audio signal from a second sound receiver;
performing a voice activity detection based on the first audio signal or the second audio signal, thereby determining whether a voice activity is present; and
training a filter based on the first audio signal and the second audio signal when the voice activity is present, thereby finding optimal filter coefficients for optimizing the filter, wherein the optimal filter coefficients reflect a frequency response difference between two acoustic paths from a wearer's mouth to the first and second sound receivers respectively; and
performing a detection phase, and the detection phase comprises steps of:
receiving the first audio signal from the first sound receiver and receiving the second audio signal from the second sound receiver;
filtering the first audio signal by the filter with the optimal filter coefficients to obtain a third audio signal;
comparing the third audio signal and the second audio signal to obtain a similarity index between the third audio signal and the second audio signal; and
determining that the first audio signal and the second audio signal contain own voice when the similarity index is greater than a threshold.

13. The own voice detection method of claim 12, wherein the training phase is performed in a silent environment, and a sound pressure level of the silent environment does not exceed 50 decibels.

14. The own voice detection method of claim 12, wherein the similarity index is a cosine similarity between the third audio signal and the second audio signal.

15. The own voice detection method of claim 12, wherein the similarity index is a correlation coefficient between the third audio signal and the second audio signal.

16. The own voice detection method of claim 12, wherein the optimal filter coefficients are found by optimizing the filter according to an objective function:
$${min}_{h} E [ {Mic}_{2} - h * {Mic}_{1} ] ,$$
wherein h is a vector of filter coefficients, Mic₁ is the first audio signal, Mic₂ is the second audio signal, and E is a mathematical expectation, and wherein the optimal filter coefficients are the filter coefficients that make the objective function attains a minimum value.

17. The own voice detection method of claim 12, wherein the optimal filter coefficients are found by utilizing a least mean square error algorithm, a normalized least mean square error algorithm, or an adaptive least mean square error algorithm.

18. The own voice detection method of claim 12, wherein the filter is optimized by steps of: performing a mathematical operation on the first audio signal to obtain the third audio signal, and then calculating the optimal filter coefficients by performing an optimization process with a goal to maximize the similarity index between the third audio signal and the second audio signal.

19. The own voice detection method of claim 18, wherein when the filter is optimized in time domain, the mathematical operation is convolution.

20. The own voice detection method of claim 18, wherein when the filter is optimized in frequency domain, the mathematical operation is multiplication.
